(19) United States
(12) Patent Application Publication
(10) Pub. No.: US 2008/0111661 A1
(43) Pub. Date: May 15, 2008

(54) Method and system for transmission power reduction in RFID interrogators

(75) Inventors: Lang Lin, Potomac, MD (US); Seok Ho Kim, North Potomac, MD (US); Jens Arnold, Perry Hall, MD (US); Mohammad Soleimani, Gaithersburg, MD (US); Victor Hugo Molina, Germantown, MD (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Symbol Technologies, Inc., Holtsville, NY (US)

(21) Appl. No.: 11/599,387

(22) Filed: Nov. 15, 2006

(51) Int. Cl. H04Q 5/22

(52) U.S. Cl. 340/10.1

(57) ABSTRACT

Methods, systems, and apparatuses for reading tags of tag populations are described. Rather than interrogating a tag population in a single query round, interrogations of tag populations are performed using reduced transmit power levels over multiple query rounds, each query round reading a portion of the tag population. In this manner, an overall power amount expended to transmit interrogations signals is reduced, while maintaining a substantially similar read rate as in single query round interrogations.

### BACKGROUND OF THE INVENTION

1. Field of the Invention

The present invention relates to wireless communications, and more particularly, to radio frequency identification (RFID) communication systems including RFID readers that communicate with RFID tags.

2. Background Art

Radio frequency identification (RFID) tags are electronic devices that may be affixed to items whose presence is to be detected and/or monitored. The presence of an RFID tag, and therefore the presence of the item to which the tag is affixed, may be checked and monitored wirelessly by devices known as “readers.” Readers typically have one or more antennas transmitting radio frequency signals to which tags respond. Since the reader “interrogates” RFID tags, and receives signals back from the tags in response to the interrogation, the reader is sometimes termed as “reader interrogator” or simply “interrogator”.

In a RFID system, typically a reader transmits a continuous wave (CW) or modulated radio frequency (RF) signal to a tag. The tag receives the signal, and responds by modulating the signal, “backscattering” an information signal to the reader. The reader receives signals back from the tag, and the signals are demodulated, decoded and further processed.

With the maturation of RFID technology, efficient communications between tags and readers has become a key enabler in supply chain management, especially in manufacturing, shipping, and retail industries, as well as in building security installations, healthcare facilities, libraries, airports, warehouses etc.

A critical issue in the deployment of mobile/handheld RFID interrogators is power consumption. A high level of power consumption in RFID interrogators leads to the need for frequent battery replacement or recharging, which can be expensive, time consuming, and bothersome to users of the interrogators. In a mobile RFID interrogator, the operation of transmitting signals consumes the largest proportion of all power consumed by the device. Thus, ways to reduce power consumed by transmitting signal are desired.

### BRIEF SUMMARY OF THE INVENTION

Methods, systems, and apparatuses for reading tags of tag populations are described. Conventionally, interrogations of tag populations are performed in either one query round or multiple query rounds with a fixed transmit power level configured so that an interrogator is capable to read any tag of the tag population in any query round. Therefore, the fixed transmit power level is determined by regulations and/or the geometry and other characteristics of the overall environment. A typical choice of the fixed transmit power level is the maximum transmit power level allowed.

According to aspects of the present invention, interrogations of tag populations are performed using a set of reduced transmit power levels over multiple query rounds, each query round reading a designated subset of the tag population. In this manner, the transmit power levels are also determined by the tag population and the tag distribution. An overall power amount expended to transmit interrogations signals is reduced, while maintaining a substantially similar read rate.

In an aspect of the present invention, a radio frequency identification (RFID) tag population is interrogated. A first transmit power level to interrogate the tag population in the single query round is determined by regulations, the geometry, and/or other characteristic of the overall environment. The number of tags in a tag population is determined, such as be either acquiring or estimating the number. The number of time slots to interrogate the estimated number of tags in a single query round is determined. A Q value is determined based on the determined number of time slots. The determined Q value is reduced to generate a reduced Q value. A first reduced transmit power level that is less than the determined first transmit power level is determined. A first query round is performed to interrogate a first group of tags of the tag population based on the reduced Q value and the first reduced transmit power level. A second reduced transmit power level that is less than the determined first transmit power level and greater than the first reduced transmit power level is determined. A second query round is performed to interrogate a second group of tags of the tag population based on the reduced Q value and the second reduced transmit power level.

In an aspect, a combination of the first group of tags and the second group of tags is substantially equal to the tag population. Thus, a read rate of the tag population is maintained relative to conventional single round queries.

In a further aspect, a third reduced transmit power level that is less than the determined first transmit power level and greater than the second reduced transmit power level may be determined. A third query round may be performed to interrogate a third group of tags of the tag population based on the reduced Q value and the third reduced transmit power level. A combination of the first group of tags, the second group of tags, and the third group of tags is substantially equal to the tag population.

In still further aspects, any number of subsequent reduced transmit power levels may be determined, and subsequent query rounds may be performed based on the reduced Q value and the subsequent reduced transmit power levels, as desired. Furthermore, the reduced transmit power levels may be decreased or increased relative to each other in any order.

In another aspect of the present invention, a radio frequency identification (RFID) communications device, such as a reader, is provided. The RFID device includes an antenna, a transmitter coupled to the antenna, and a logic module. The transmitter is configured to generate at least one interrogation signal that is transmitted by the antenna. The logic module is configured to receive a Q value and a first transmit power level that are configured to interrogate a tag population in a single query round. The logic module is configured to generate a reduced Q value from the received Q value, to determine a first reduced transmit power level that is less than the determined first transmit power level, and to determine a second reduced transmit power level that is less than the determined first transmit power level and is greater than the first reduced transmit power level.

In a further aspect, the transmitter is configured to perform a first query round to interrogate a first group of tags of the tag population based on the reduced Q value and the first reduced transmit power level. The transmitter is further configured to perform a second query round to interrogate a second group of tags of the tag population based on the reduced Q value and the second reduced transmit power level.

These and other objects, advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows an environment where RFID readers communicate with an exemplary population of RFID tags.

FIG. 2 shows a block diagram of receiver and transmitter portions of an RFID reader.

FIG. 3 shows a block diagram of an example radio frequency identification (RFID) tag.

FIG. 3 illustrates an example timing diagram of an interrogation of a tag population resulting in a single response.

FIG. 4 illustrates an example timing diagram of an interrogation of a tag population resulting in a collided time slot and an empty time slot.

FIG. 5 shows a flowchart providing example steps for interrogating tags in a tag population, according to an example embodiment of the present invention.

FIGS. 6 and 7 illustrate a conventional interrogation of a tag population in a single query round.

FIGS. 8 and 9 illustrate an interrogation of a tag population in a first query round of a multiple query round interrogation, according to an example embodiment of the present invention.

FIGS. 10 and 11 illustrate an interrogation of a tag population in a second query round of a multiple query round interrogation, according to an example embodiment of the present invention.

FIG. 12 shows example additional steps for the flowchart of FIG. 5, according to embodiments of the present invention.

FIG. 13 shows an example RFID communications device, according to an example embodiment of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner. Likewise, particular bit values of “0” or “1” (and representative voltage values) are used in illustrative examples provided herein to represent data for purposes of illustration only. Data described herein can be represented by either bit value (and by alternative voltage values), and embodiments described herein can be configured to operate on either bit value (and any representative voltage value), as would be understood by persons skilled in the relevant art(s).

### Example RFID System Embodiment

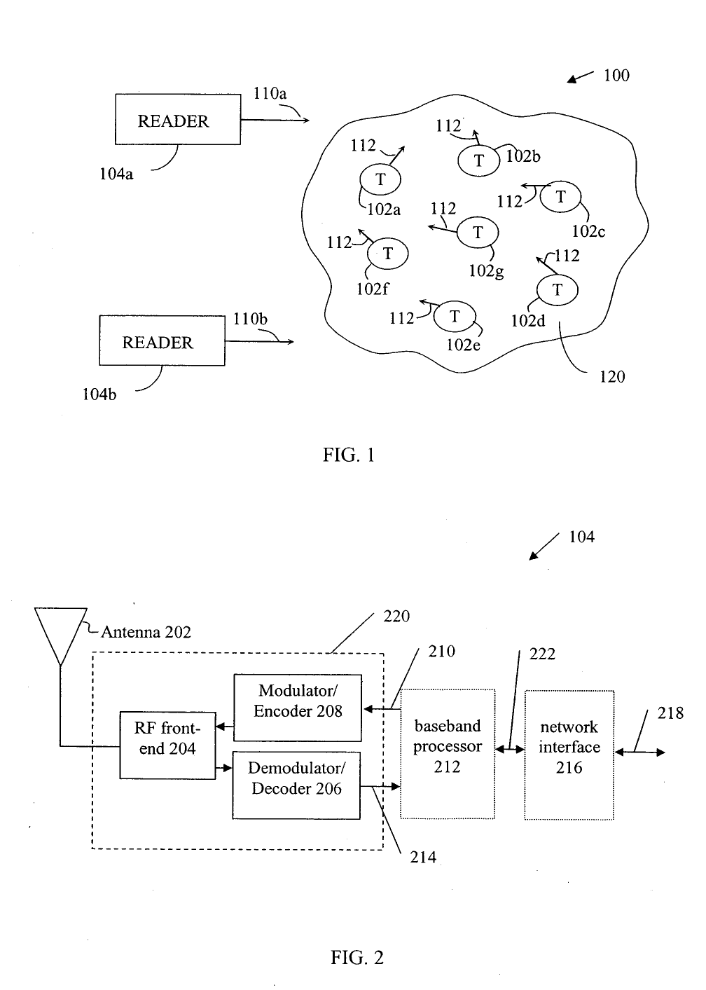

Before describing embodiments of the present invention in detail, it is helpful to describe an example RFID communications environment in which the invention may be implemented. FIG. 1 illustrates an environment 100 where RFID tag readers 104 communicate with an exemplary population 120 of RFID tags 102. As shown in FIG. 1, the population 120 of tags includes seven tags 102a-102g. A population 120 may include any number of tags 102.

Environment 100 includes any number of one or more readers 104. For example, environment 100 includes a first reader 104a and a second reader 104b. Readers 104a and/or 104b may be requested by an external application to address the population of tags 120. Alternatively, reader 104a and/or reader 104b may have internal logic that initiates communication, or may have a trigger mechanism that an operator of a reader 104 uses to initiate communication. Readers 104a and 104b may also communicate with each other in a reader network.

As shown in FIG. 1, reader 104a transmits an interrogation signal 110 having a carrier frequency to the population of tags 120. Reader 104b transmits an interrogation signal 110b having a carrier frequency to the population of tags 120. Readers 104a and 104b typically operate in one or more of the frequency bands allotted for this type of RF communication. For example, frequency bands of 860-960 MHz, including 902-928 MHz, and 2400-2483.5 MHz have been defined for certain RFID applications by the Federal Communication Commission (FCC).

Various types of tags 102 may be present in tag population 120 that transmit one or more response signals 112 to an interrogating reader 104, including by alternatively reflecting and absorbing portions of signal 110 according to a time-based pattern or frequency. This technique for alternatively absorbing and reflecting signal 110 is referred to herein as backscatter modulation. Readers 104a and 104b receive and obtain data from response signals 112, such as an identification number of the responding tag 102. In the embodiments described herein, a reader may be capable of communicating with tags 102 according to any suitable communication protocol, including Class 0, Class 1, EPC Gen 2, other binary traversal protocols and slotted aloha protocols, any other protocols mentioned elsewhere herein, and future communication protocols.

FIG. 2 shows a block diagram of an example RFID reader 104. Reader 104 includes one or more antennas 202, a receiver and transmitter portion 220 (also referred to as transceiver 220), a baseband processor 212, and a network interface 216. These components of reader 104 may include software, hardware, and/or firmware, or any combination thereof, for performing their functions.

Baseband processor 212 and network interface 216 are optionally present in reader 104. Baseband processor 212 may be present in reader 104, or may be located remote from reader 104. For example, in an embodiment, network interface 216 may be present in reader 104, to communicate between transceiver portion 220 and a remote server that includes baseband processor 212. When baseband processor 212 is present in reader 104, network interface 216 may be optionally present to communicate between baseband processor 212 and a remote server. In another embodiment, network interface 216 is not present in reader 104.

In an embodiment, reader 104 includes network interface 216 to interface reader 104 with a communications network 218. As shown in FIG. 2, baseband processor 212 and network interface 216 communicate with each other via a communication link 222. Network interface 216 is used to provide an interrogation request 210 to transceiver portion 220 (optionally through baseband processor 212), which may be received from a remote server coupled to communications network 218. Baseband processor 212 optionally processes the data of interrogation request 210 prior to being sent to transceiver portion 220. Transceiver 220 transmits the interrogation request via antenna 202.

Reader 104 has at least one antenna 202 for communicating with tags 102 and/or other readers 104. Antenna(s) 202 may be any type of reader antenna known to persons skilled in the relevant art(s), including a vertical, dipole, loop, Yagi-Uda, slot, or patch antenna type. For description of an example antenna suitable for reader 104, refer to U.S. Ser. No. 11/265,143, filed Nov. 3, 2005, titled “Low Return Loss Rugged RFID Antenna,” now pending, which is incorporated by reference herein in its entirety.

Transceiver 220 receives a tag response via antenna 202. Transceiver 220 outputs a decoded data signal 214 generated from the tag response. Network interface 216 is used to transmit decoded data signal 214 received from transceiver portion 220 (optionally through baseband processor 212) to a remote server coupled to communications network 218. Baseband processor 212 optionally processes the data of decoded data signal 214 prior to being sent over communications network 218.

In embodiments, network interface 216 enables a wired and/or wireless connection with communications network 218. For example, network interface 216 may enable a wireless local area network (WLAN) link (including a IEEE 802.11 WLAN standard link), a BLUETOOTH link, and/or other types of wireless communication links. Communications network 218 may be a local area network (LAN), a wide area network (WAN) (e.g., the Internet), and/or a personal area network (PAN).

In embodiments, a variety of mechanisms may be used to initiate an interrogation request by reader 104. For example, an interrogation request may be initiated by a remote computer system/server that communicates with reader 104 over communications network 218. Alternatively, reader 104 may include a finger-trigger mechanism, a keyboard, a graphical user interface (GUI), and/or a voice activated mechanism with which a user of reader 104 may interact to initiate an interrogation by reader 104.

In the example of FIG. 2, transceiver portion 220 includes a RF front-end 204, a demodulator/decoder 206, and a modulator/encoder 208. These components of transceiver 220 may include software, hardware, and/or firmware, or any combination thereof, for performing their functions. Example description of these components is provided as follows.

Modulator/encoder 208 receives interrogation request 210, and is coupled to an input of RF front-end 204. Modulator/encoder 208 encodes interrogation request 210 into a signal format, modulates the encoded signal, and outputs the modulated encoded interrogation signal to RF front-end 204. For example, pulse-interval encoding (PIE) may be used in a Gen 2 embodiment. Furthermore, double sideband amplitude shift keying (DSB-ASK), single sideband amplitude shift keying (SSB-ASK), or phase-reversal amplitude shift keying (PR-ASK) modulation schemes may be used in a Gen 2 embodiment. Note that in an embodiment, baseband processor 212 may alternatively perform the encoding function of modulator/encoder 208.

RF front-end 204 may include one or more antenna matching elements, amplifiers, filters, an echo-cancellation unit, a down-converter, and/or an up-converter. RF front-end 204 receives a modulated encoded interrogation signal from modulator/encoder 208, up-converts (if necessary) the interrogation signal, and transmits the interrogation signal to antenna 202 to be radiated. Furthermore, RF front-end 204 receives a tag response signal through antenna 202 and down-converts (if necessary) the response signal to a frequency range amenable to further signal processing.

Demodulator/decoder 206 is coupled to an output of RF front-end 204, receiving a modulated tag response signal from RF front-end 204. In an EPC Gen 2 protocol environment, for example, the received modulated tag response signal may have been modulated according to amplitude shift keying (ASK) or phase shift keying (PSK) modulation techniques. Demodulator/decoder 206 demodulates the tag response signal. For example, the tag response signal may include backscattered data formatted according to FM0 or Miller encoding formats in an EPC Gen 2 embodiment. Demodulator/decoder 206 outputs decoded data signal 214. Note that in an embodiment, baseband processor 212 may alternatively perform the decoding function of demodulator/decoder 206.

The configuration of transceiver 220 shown in FIG. 2 is provided for purposes of illustration, and is not intended to be limiting. Transceiver 220 may be configured in numerous ways to modulate, transmit, receive, and demodulate RFID communication signals, as would be known to persons skilled in the relevant art(s).

The following terms are described in the “EPC™ Radio-Frequency Identity Protocols Class-1 Generation-2 UHF RFID Protocol for Communications at 860 MHz-960 MHz,” Version 1.0.9 (commonly referred to as Gen 2), and published 2004, which is incorporated by reference herein in its entirety. These terms are provided for use with regards to example embodiments of the invention described further below. It will be appreciated that the meaning of these terms provided below may be modified in embodiments without deviating from the spirit of the invention.

Q—is a time slot count parameter that an interrogator provides to tags to control a distribution of tag responses. In a Gen 2 embodiment, Q is an integer in the range of 0 to 15. In an embodiment, an interrogator commands tags in an inventory round to load a Q-bit number into their time slot counter. Typically, each tag independently generates the Q-bit number. The Q-bit number dictates which time slot the tags will respond to an interrogation.

Query—a Query command initiates an inventory round and determines which tags participate in the round. A Query command contains the parameter Q.

QueryAdjust—a QueryAdjust command repeats a previous Query and may increment or decrement Q, but does not introduce new tags into the round. QueryAdjust adjusts Q without changing any other parameters of the round.

QueryRep—a QueryRep command repeats a previous Query command without changing any parameters and without introducing new tags into the round. In a Gen2 context, the QueryRep command instructs tags to decrement the value stored in their slot counters. If the slot counter stores a 0 value after decrementing, the tag backscatters a response to the interrogator. In a Gen 2 embodiment, the tag generates a 16-bit random value, RN16, and backscatters the random value to the interrogator.

Inventory round—an inventory round is the period between successive Query commands. During an inventory round, an interrogator attempts to interrogate one or more time slots, e.g., using a Query, QueryAdjust, or QueryRep command.

Slot—a “slot” or “time slot” corresponds to a point in an inventory round at which a tag may respond. Tags reply when their slot (e.g. the value in their slot counter) is zero.

Single response time slot—refers to a time slot in which a single tag responds to an interrogation.

Collided or contended time slots—refers to a time slot in which more then one tag responds to an interrogation, resulting in a collision.

Empty time slot—refers to a time slot in which no tags respond.

In addition, the terms “interrogator” and “reader” are used synonymously herein to refer to a device that communicates with and issues commands to RFID tags.

The present invention is applicable to any type of RFID tag, including passive tags and active tags, and semiconductor-based tags and surface acoustic wave (SAW) tags. Thus, for purposes of brevity the structure and operation of specific types of RFID tags are not described in detail herein. There are several manners in which an RFID tag can respond to a reader during an interrogation. A few examples are described below.

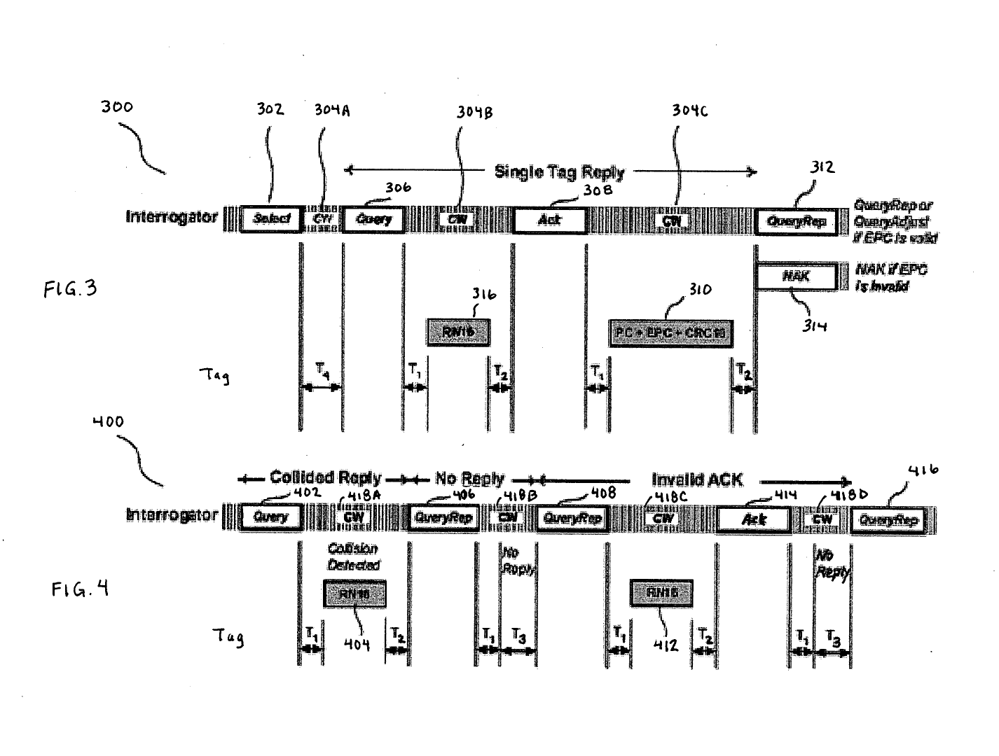

In a RFID environment employing a slotted-ALOHA protocol, such as EPC Gen 2, tags respond to reader interrogations during time slots. As described above, several types of time slots are possible, including single response time slots, collided time slots, and empty time slots. FIG. 3 illustrates an example timing diagram 300 of an interrogation resulting in a single response. FIG. 4 illustrates an example timing diagram 400 of an interrogation resulting in a collided time slot and an empty time slot. FIGS. 3 and 4 are annotated reproductions of a figure shown in the aforementioned Gen 2 specification, and are further described as follows. Timing diagrams 300 and 400 are provided for illustrative purposes, and are not intended to be limiting.

The interrogation illustrated by FIG. 3 begins in a time block 302 in which the interrogator (reader) transmits an optional Select command, which selects a particular RFID tag population based on user-defined criteria. The interrogator transmits a continuous wave (CW) (e.g. to power tags) 304A for a duration T4, which is a minimum time between interrogator commands. An inventory round (also referred to herein as an interrogation) of the selected population is initiated by a Query command 306 sent by the interrogator. The interrogator transmits a continuous wave 304B following Query command 306. In response to Query command 306, tags in the selected population randomly choose a time slot in which to respond to the interrogator. An example method by which the tags choose a time slot in which to respond to the interrogator is described below.

When a time slot in which a tag is designated to respond arrives, the tag responds. For example, as shown in FIG. 3, a tag responds to Query command 306 after a time T1 by sending its 16 bit random number (RN16) 316. Time T1 is the time from the interrogator transmission (e.g., Query command 306) to the tag response (e.g., RN16). After a time T2 (e.g., the time required if a tag is to demodulate the interrogator signal), the interrogator transmits an Ack command 308. The interrogator transmits Ack command 308 to acknowledge a single tag. The interrogator transmits a continuous wave 304C following Ack command 308. After the tag receives Ack command 308, the tag transmits data to the interrogator as indicated in tag data block 310. For example, the tag may transmit its protocol control (PC), a specific UID known as an electronic product code (EPC), and a 16-bit cyclic redundancy check (CRC16) bit pattern. After the tag transmits the information in tag data block 310, the interrogator transmits a QueryRep command 312 or a Nak command 314. QueryRep command 312 is sent if the EPC is valid, and it instructs other tags in the selected population to decrement their slot counters by one-effectively moving the entire tag population to the next time slot. Nak command 314 is transmitted if the EPC is invalid.

A method by which the tags choose a time slot in which to respond to the interrogator is now described. The number of time slots available in which to respond to the interrogator may be equal to 2^{Q} . . . e.g., for a 16 time slot configuration, Q is equal to 4, and for a 64 time slot configuration, Q is equal to 6. A tag stores the value of Q (which may be initially received from the interrogator) in tag memory. A random number generator (RNG) module of the tag uses the value of Q to randomly generate a 16-bit number (RN16), which is stored in tag memory. In one example, a tag uses a portion of RN16 (e.g., the four least significant bits for a 16 time slots round) to determine a time slot in which to respond to the interrogator, and masks the remaining numbers. Thus, a tag may store the following 16-bit number after this process:
0000000000001011,
   where “000000000000” is the masked portion, and “1011” is the remaining 4-bit random value. Since the binary number 1011 is equal to the decimal number 11, a tag in this example is designated to respond in time slot 12 (when counting time slots from 1). Each time the interrogator broadcasts a next slot signal (e.g., a QueryRep command, as described herein), the tag counts down from 12. When time slot 12 arrives, the tag responds to the interrogator.

As mentioned above, timing diagram 400 of FIG. 4 illustrates an interrogation in which more than one tag responds in a time slot, no tags respond in a time slot, and a tag response is invalid. Timing diagram 400 begins in a time period in which an interrogator transmits a Query command 402. The interrogator transmits a continuous wave (CW) 418A following Query command 402. After a time T1, more than one tag transmits a 16-bit random number, shown as collided RN16 404. Because of the collision, typically no valid tag response is received at collided RN16 404. After a time T2, the interrogator transmits a QueryRep command 406, instructing the tags to decrement their slot counters to move to the next time slot. Due to the collision, no attempt is made at further communications with a tag between Query command 402 and QueryRep command 406. The interrogator transmits a continuous wave 418B after QueryRep command 406.

As shown in timing diagram 400, after QueryRep command 406, no reply is received during a time interval T3 because there are no tags in the population designated to respond in this time slot. Because no tags respond during time interval T3, the interrogator issues a QueryRep command 408 to move to the next time slot. Time interval T3 is made shorter than a normal tag response period by the interrogator due to the lack of tag response. The interrogator transmits a continuous wave 418C after QueryRep command 408.

In a time period following QueryRep command 408 and after a time interval T1, a tag transmits a 16-bit random number RN16 412. In response, the interrogator issues an Ack command 414 followed by a continuous wave 418D. However, Ack command 414 is invalid. Typically, in a Gen 2 environment, an Ack command includes the RN16 value just received from a tag. However, an Ack command can be invalid, for example, if an incorrect 16-bit random number RN16 is transmitted with the Ack command. Since in this example Ack command 414 is invalid, no tags respond during time interval T3. Thus, the interrogator issues another QueryRep command 416 to move to a next time slot.

For a typical interrogator, its transmission power is fixed to be the maximum allowed by FCC part 15. If a tag population is large, it is desirable to select Q to be a large value in order to reduce the number of collisions. If a tag population is small, it is desirable to select Q to be a small value in order to not waste time and slow down the reading process. A fundamental assumption in the conventional selection of Q is to use a fixed transmission power that is reasonable for a particular interrogator location. Embodiments of the present invention improve the power utilization for interrogators, including mobile/handheld interrogators, without a loss in reading rate of tag by a combination of proper Q selection and transmission power control.

Example embodiments of the present invention are described in further detail below. Such embodiments may be implemented in the environments and readers described above, and/or in alternative environments and alternative RFID devices.

### Example Embodiments

Methods, systems, and apparatuses for reading tags while reducing power used to transmit interrogation signals to tags are described. Conventionally, interrogations of tag populations are performed using a transmit power level configured to read all the tags of the tag population in a single query round. According to embodiments of the present invention, interrogations of tag populations are performed using reduced transmit power levels over multiple query rounds, each query round reading a portion of the tag population. In this manner, an overall power amount expended to transmit interrogations signals is reduced, while maintaining a substantially similar read rate.

Multiple round interrogations may be used instead of single round interrogations, because for reasonably large Q (e.g., Q≧4), the reading rate remains the same for two scenarios:

Scenario A (conventional): a single round of query is performed by an interrogator using a fixed transmission power P_{A} and a fixed slot count Q_{A}.

Scenario B: Two rounds of query are performed by an interrogator using a reduced slot count relative to Scenario A (Q_{B}=Q_{A}−1) and a transmission power P_{B} that is configured to read about half of the tags read by Scenario A.

Thus, transmission power and slot count (P, Q) may be adjusted to perform multiple query rounds, to reduce overall consumed transmission power without reduction of reading rate as compared to a single round conventional interrogation. The relationship between Scenarios A and B is further described as follows.

As mentioned above, an inventory round has 2^{Q} time slots separated by QueryRep commands. A tag participating in the query round randomly chooses one time slot out of the 2^{Q} time slots to respond to a query command issued by the interrogator. Given a tag population of n tags, the average number of readable tags in a query round is:

R(Q, n)=n(1−2^{-Q})ⁿ⁻¹ Equation 1

Given Q, the maximum number of tags that can be harvested in a query round is

R(Q, nₚₑₐₖ)≈2^{Q}/e Equation 2

where:

nₚₑₐₖ≈2^{Q} Equation 3

Therefore, if a number of slots determined for a particular query round is reasonably accurate, the time duration of a query round is dominated by the successful reads, which may last a few milliseconds each. Ignoring the overhead between successive query rounds, Equation 1 can be used to determine the equivalence between single query rounds and multi-query rounds:

$$\begin{matrix}R ( Q + 1 , 2 n ) = 2 {n ( 1 - {2}^{- Q - 1} )}^{2 n - 1} \\ = 2 {n ( 1 - {2}^{- Q} )}^{n - 1} {( 1 - {2}^{- Q - 1} )}^{2 n - 1} / {( 1 - {2}^{- Q} )}^{n - 1} \\ = 2 R ( Q , n ) {( 1 - {2}^{- Q - 1} )}^{2 n - 1} / {( 1 - {2}^{- Q} )}^{n - 1}\end{matrix} \\ R ( Q + 1 , 2 n ) \approx 2 R ( Q , n ) \qquad Equation 4$$

for relatively large Q (Q>=4). Equation (4) indicates that Scenarios A and B described above have the same reading rate. In Scenario B, 2R(Q, n) indicates that a reduced Q value is used and lower number of tags (n) is interrogated per query round verses Scenario A, R(Q+1, 2n), but that two query rounds may be performed to provide equivalence.

Thus, in an embodiment, a first query round can be performed using a lower transmission power to interrogate nearby tags, while a relatively higher transmission power can be used in a second (or further) query round to interrogate tags farther away. Thus, in embodiments, a lower transmission power is used to read adjacent tags. The transmission power is then increased to progressively scan tags that are farther away. If a density of the tag distribution is known, the size of a visible tag population for an interrogator can be controlled by the transmission power. In embodiments, during a reading process, an interrogator adjusts its transmission power and slot count in query rounds to reduce an overall transmission power without loss in the reading rate.

In embodiments, the transmission power and the slot count pair (P, Q) may be configured for a query round in various ways. For instance, Table 1 shows values for transmission power for example embodiments where two query rounds are performed to reduce consumed transmit power in 2-dimensional (2D) and 3-dimensional (3D) environments:

TABLE 1

| | Con- | | |
|---|---|---|---|
| | ventional | | |
| | single | | |
| | round, | | |
| | using | Example Embodiments | |
| | Q + 1 | multiple rounds, using Q | |
| | P (single | P (first | |
| | round) | round) | P (second round) |
| 2D | 1 | .5 | .5 + R(Q,n)/2n ≦ .5 + 1/2e ≈ 0.68 |
| 3D | 1 | .63 | {[n + R(Q,n)]/2n}^{2/3} ≦ {.5 + 1/2e}^{2/3} ≈ 0.78 |

According to Table 1, for tags relatively evenly distributed in a 2-dimensional plane together with an interrogator in a conventional situation, a single query round would be performed using a normalized transmit power level of 1, and a Q value of Q+1. In contrast, according to an embodiment, first and second query rounds are performed using Q values of Q (i.e., using a Q value of one less than the conventional situation). The first query round is performed using a transmit power level of 0.5 and the second query round is performed using a transmit power level of 0.68. This 2D embodiment using first and second query rounds in this manner consumes 40% less transmission power than does the conventional single query round, and has substantially the same overall read rate as the conventional situation.

For tags relatively evenly distributed in a 3-dimensional plane together with an interrogator in a conventional situation, a single query round would be performed using a normalized transmit power level of 1, and a Q value of Q+1. In contrast, according to an embodiment, first and second query rounds are performed using Q values of Q. The first query round is performed using a transmit power level of 0.63 and the second query round is performed using a transmit power level of 0.78. This 3D embodiment using first and second query rounds in this manner also consumes less transmission power than does the conventional single query round, and has substantially the same overall read rate as the conventional situation.

Thus, in embodiments, multiple query rounds are performed having reduced Q values and reduced transmit power, to provide the same overall read rate as conventional systems but less overall transmit power consumed. Note that the examples embodiments described above mention using two (first and second) query rounds for illustrative purposes. In embodiments, any number of two or more query rounds may be performed with reduced transmit power levels and reduced Q values to provide similar overall read rates, but less overall transmit power consumed, including three query rounds, four query rounds, etc., as would be understood by persons skilled in the relevant art(s) from the teachings herein.

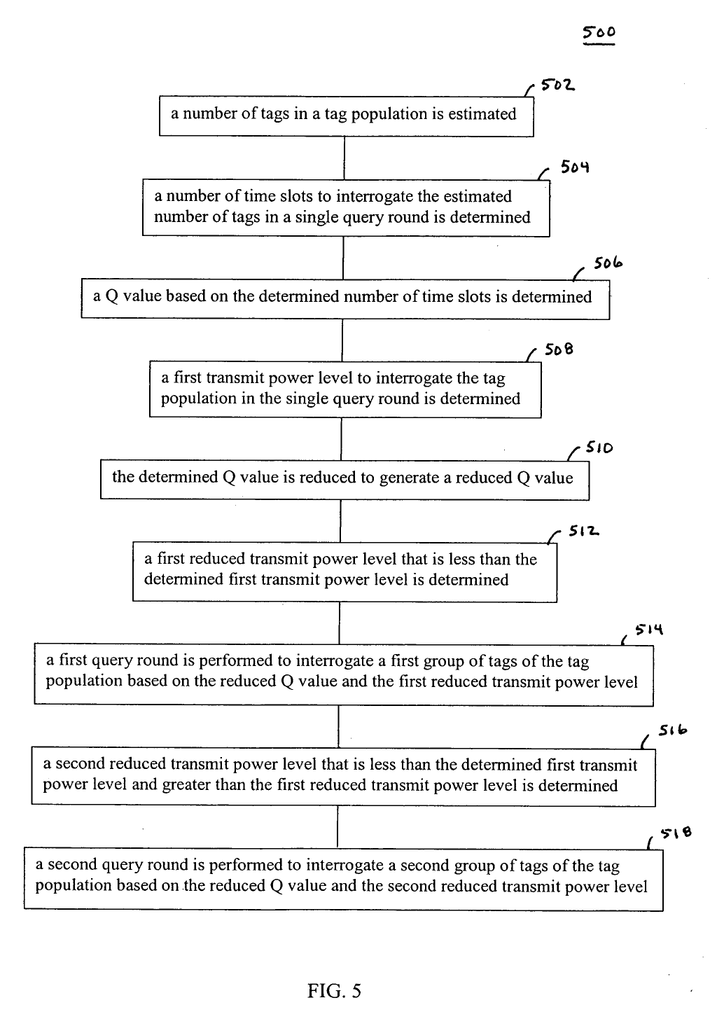

FIG. 5 shows a flowchart 500 providing example steps for interrogating tags in a tag population, according to example embodiments of the present invention. Other structural and operational embodiments will be apparent to persons skilled in the relevant art(s) based on the following discussion. The steps of flowchart 500 do not necessarily have to occur in the order shown. In some embodiments, not all steps of flowchart 500 are necessary, as indicated in some examples below.

Flowchart 500 begins with step 502. In step 502, a number of tags in a tag population is estimated. For example, as shown in FIG. 1, tag population 120 may be estimated to include around seven tags 102. Any manner, conventionally or otherwise, may be used to estimate a number of tags in a tag population.

In step 504, a number of time slots to interrogate the estimated number of tags in a single query round is determined. For example, in an embodiment, a number of time slots may be chosen as an exponent of 2, such as 2 slots (2¹), 4 slots (2²), 8 slots (2³), 16 slots (2⁴), 32 slots (2⁵), 64 slots (2⁶), etc. The number of time slots may be chosen as a minimal value that allows each tag of the estimated number of tags in step 502 to have their own time slot for response (such as in the single tag response time slot example described above with respect to FIG. 3), or may be chosen in another manner. In the present example, 8 time slots may be chosen as a minimal exponent of 2 that allows all estimated seven tags 102 to have their own slot.

In step 506, a Q value based on the determined number of time slots is determined. For example, in a Gen 2 embodiment, a Q value may be determined based on the relationship described above of:

number of time slots=2^{Q}, where Q is an integer Equation 5

For example, in the current example, the number of time slots was determined in step 504 to be 8 time slots. Thus, Equation 5 is as follows:

8 time slots=2^{Q}

Q can be solved for as follows:

log 8=log(2^{Q})

log 8=Q×log 2

Q=3

### Thus, in the current example, Q is equal to 3.

In step 508, a first transmit power level to interrogate the tag population in the single query round is determined. The first transmit power level may determined in any manner as would be done, conventionally or otherwise, to determine a transmit power level for a RFID reader-type device to read the tag population. Factors that may be taken into account in this determination may include distance to the outermost tags, obstacles (e.g., that may create reflections), the transmitting antenna-type, etc. For ease of illustration in the current example, the first transmit power level will be assumed to be 1.0 (e.g., Watt).

Note that in embodiments, one or more of steps 502-508 may be performed separately from the following steps (e.g., by a person, computing system, a separate RFID device, etc.). Thus, a device performing the following steps may receive or already have stored one or more of the values determined above, including estimated number of tags, number of time slots, Q value, and/or first transmit power level. Thus, in some embodiments, steps 502-508 are not required, or may be performed separately from steps 510-518.

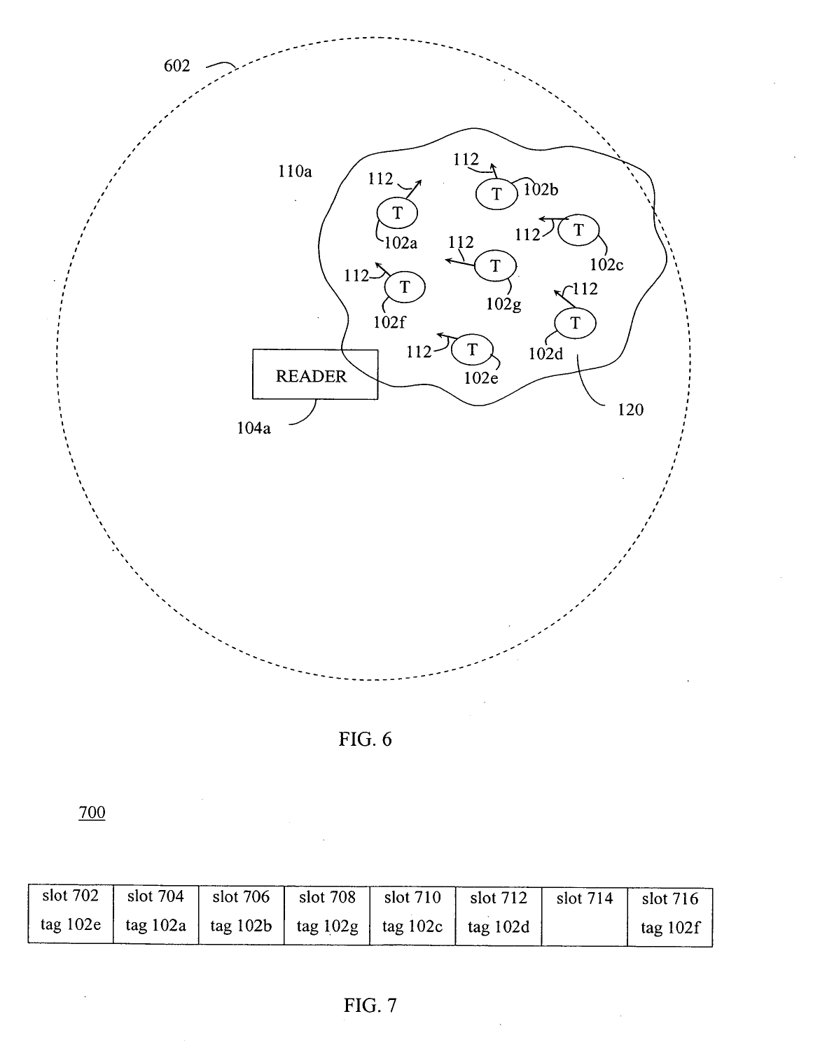

FIGS. 6 and 7 are shown to illustrate an interrogation of a tag population in a single query round in a less desirable manner. In FIG. 6, reader 104a is shown performing a query round to interrogate the seven tags 102a-102g of tag population 120 by transmitting an RFID communication signal 602 at the first transmit power level determined in step 508 (e.g., in a conventional manner). RFID communication signal 602 is configured to interrogate tag population 120 in a single query round. FIG. 7 shows a query round 700, according to an embodiment of the present invention. In the example of FIGS. 6 and 7, to perform the illustrated query round, reader 104a provides the parameter Q=3 to tag population 120, as was determined in step 506 above, to create 8 time slots (as determined in step 504) for tag responses. As shown in query round 700, tag 102e responds in time slot 702, tag 102a responds in time slot 704, tag 102b responds in time slot 706, tag 102g responds in time slot 708, tag 102c responds in time slot 710, tag 102d responds in time slot 712, no tag responds in time slot 715, and tag 102f responds in time slot 716. However, because in FIGS. 6 and 7 a single query round is used to interrogate tag population 120 at the first transmit power level, excessive power is consumed relative to embodiments of the present invention.

Note that the time slots in which tags respond may be randomly or otherwise selected by the tags. The time slot and tag response combinations shown in the drawings herein are provided for illustrative purposes, and are not limiting. Furthermore, although not shown in FIG. 7 or in the query rounds illustrated in FIGS. 9 and 11, described below, tag response collisions may occur. Such collisions may occur in a similar manner in both the conventional situations and in the embodiments described herein, and thus are not shown for purposes of brevity.

Steps 510-518 illustrate an interrogation of a tag population in multiple query rounds, while consuming less power, according to embodiments of the present invention.

In step 510, the determined Q value is reduced to generate a reduced Q value. For example, in an embodiment where two query rounds are to be performed, the determined Q value may be decreased by one, to reduce a number of time slots of a query round in half (due to the relationship of number of time slots=2^{Q}) in order to interrogate half of the tag population each query round. In another embodiment, where four query rounds are to be performed, the determined Q value may be decreased by two, to divide a number of time slots of a query round by four to interrogate one fourth of the tag population each query round. In further embodiments, the Q value may be decreased by other factors, to correspondingly reduce a number of time slots. In the current example, for illustrative purposes, the determined Q value is decreased by one, to perform two query rounds (to be performed in steps 514 and 518) that each cover approximately half of the tag population.

In step 512, a first reduced transmit power level that is less than the determined first transmit power level is determined. For example, the first reduced transmit power level may be determined in any manner, as would be known to persons skilled in the relevant art(s) from the teachings herein. For example, for a tag population substantially arranged in a two-dimensional layout, the determined first transmit power level of 1.0 determined in step 508 may be reduced in half (as shown in Table 1 for the first round), to a value of 0.5 for the first reduced transmit power level. For a tag population substantially arranged in a three-dimensional layout, the determined first transmit power level of 1.0 may be reduced by a factor of 0.63 (as shown in Table 1 for the first round), to a value of 0.63 for the first reduced transmit power level.

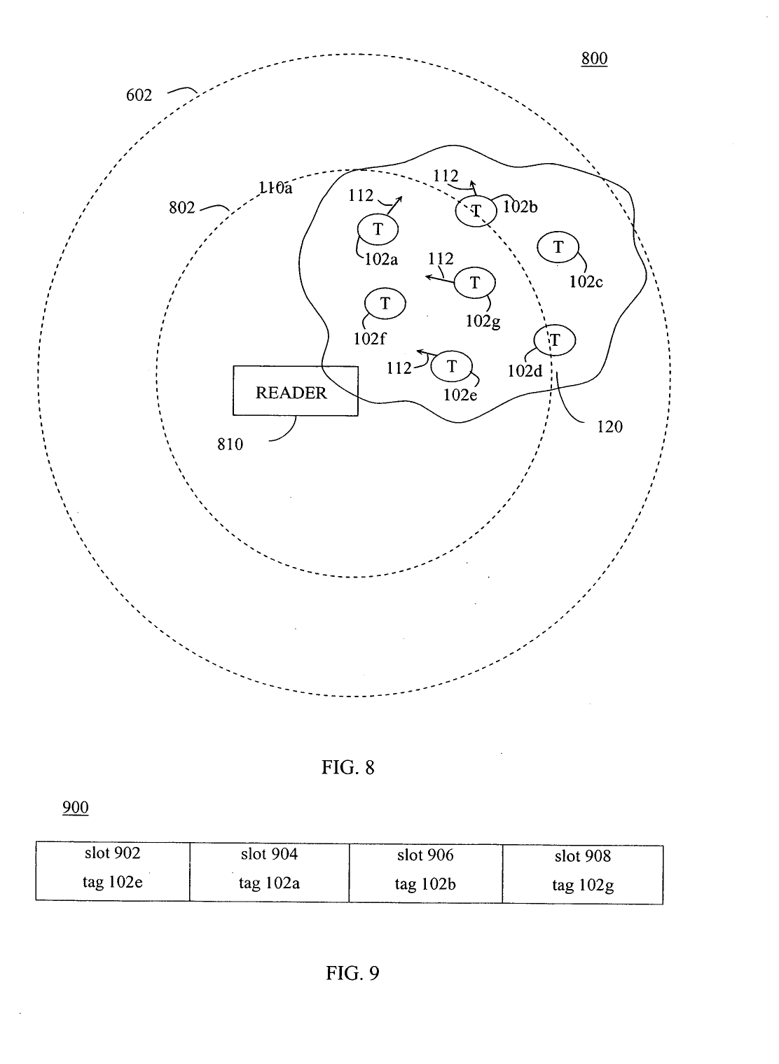

In step 514, a first query round is performed to interrogate a first group of tags of the tag population based on the reduced Q value and the first reduced transmit power level. For example, as shown in FIG. 8, a RFID communications device 810 is shown performing a first query round to interrogate the seven tags 102a-102g of tag population 120, according to an example embodiment of the present invention. RFID communications device 810 is shown transmitting an RFID communication signal 802 at a first reduced transmit power level, configured to interrogate a portion of tag population 120 a first query round, that is less than the first transmit power level of RFID communication signal 602. FIG. 9 shows a first query round 900, according to an embodiment of the present invention. In first query round 900, tag 102e responds in time slot 902, tag 102a responds in time slot 904, tag 102b responds in time slot 906, and tag 102g responds in time slot 908. Thus, in step 514, approximately half of the tag population is interrogate in the first query round. Furthermore, tags 102a, 102b, 102e, and 102g, are shut down from responding in a subsequent query round.

In step 516, a second reduced transmit power level that is less than the determined first transmit power level and greater than the first reduced transmit power level is determined. For example, similarly to step 512, the second reduced transmit power level may be determined in any manner, as would be known to persons skilled in the relevant art(s) from the teachings herein. For instance, in the current example, for a tag population substantially arranged in a two-dimensional layout, the second determined transmit power level may be selected to be 0.68, as shown in Table 1, which is less than the first transmit power level (1.0) determined in step 508 and is greater than the first reduced transmit power level (0.5) determined in step 512. For a tag population substantially arranged in a three-dimensional layout, the second determined transmit power level may be selected to be 0.78, as shown in Table 1, which is less than the first transmit power level (1.0) and is greater than the first reduced transmit power level (0.63).

Note that by increasing the second reduced transmit power level relative to the first reduced transmit power level, tags of tag population 120 that may have been out of the range of the RFID communication signal 802 (e.g., tag 102c) can be read.

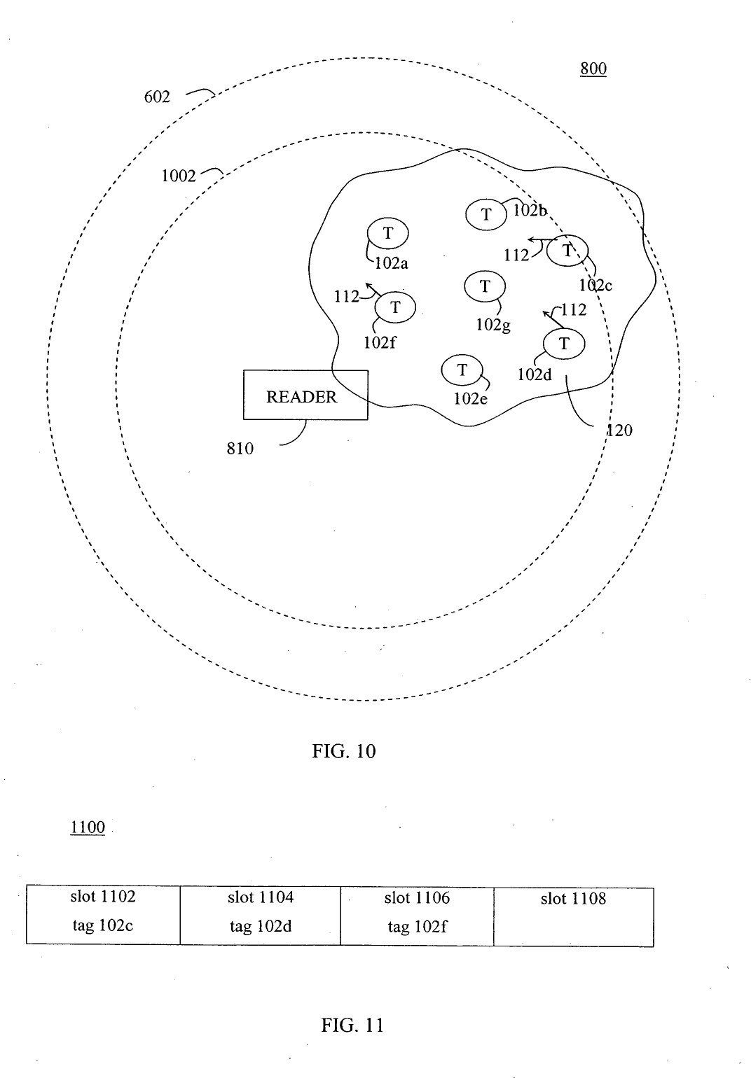

In step 518, a second query round is performed to interrogate a second group of tags of the tag population based on the reduced Q value and the second reduced transmit power level. For example, as shown in FIG. 10, RFID communications device 810 is shown performing a second query round to interrogate the seven tags 102a-102g of tag population 120, according to an example embodiment of the present invention. RFID communications device 810 is shown transmitting an RFID communication signal 1002 at a second reduced transmit power level, that is less than the first transmit power level of RFID communication signal 602 and greater than the first reduced transmit power level of RFID communication signal 802. FIG. 11 shows a timing diagram 1100 of the second query round, according to an embodiment of the present invention. As shown in timing diagram 1100, tag 102c responds in time slot 1102, tag 102d responds in time slot 1104, tag 102f responds in time slot 1106, and no tag responds in time slot 1108. Thus, in step 518, approximately half of the tag population that was not interrogated in the first query round is interrogated. Furthermore, the combination of the first reduced transmit power level and second reduced transmit power level determined in steps 512 and 516, and transmitted in steps 514 and 518, result in less transmit power consumption than performing a single round query according to the first transmit power level determined in step 508.

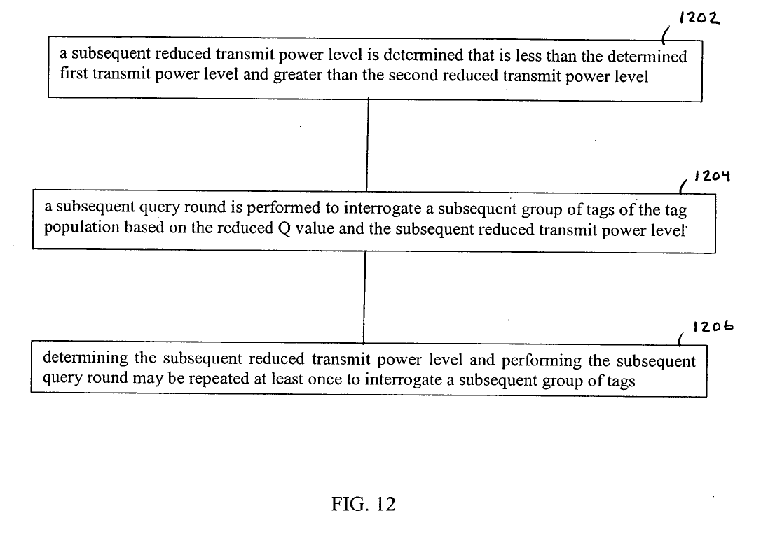

Thus, in the manner of steps 510-518, tag population 120 may be interrogated in two rounds using reduced power consumption. Furthermore, the interrogation of a tag population may performed over more than two rounds. For example, FIG. 12 shows additional example steps for flowchart 1200, according to embodiments of the present invention.

In step 1202, a subsequent reduced transmit power level is determined that is less than the determined first transmit power level and greater than the second reduced transmit power level. Thus, in an embodiment where a third query round is to be performed, step 1202 can be performed in a similar fashion to step 516, to generate a subsequent reduced transmit power level that is less than the first transmit power level determined in step 508, and greater than reduced transmit power level previously determined in step 516.

In step 1204, a subsequent query round is performed to interrogate a subsequent group of tags of the tag population based on the reduced Q value and the subsequent reduced transmit power level. For example, step 1204 can be performed in a similar fashion to step 518, using the reduced Q value determined in step 510 and the subsequent reduced transmit power level determined in step 1202. A combination of the first group of tags (step 514), the second group of tags (step 518), and the subsequent group of tags (step 1204) is substantially equal to the tag population. Furthermore, less transmit power is consumed relative to conventional single round queries.

In step 1206, determining the subsequent reduced transmit power level and performing the subsequent query round may be repeated at least once to interrogate a subsequent group of tags. Step 1206 is optional, and may be performed when more than three query rounds are to be performed to interrogate a tag population according to an embodiment of the present invention. As described above, when performing relatively large numbers of query rounds, the Q value determined in 510 may be reduced by more than one relative to the original Q value of step 506.

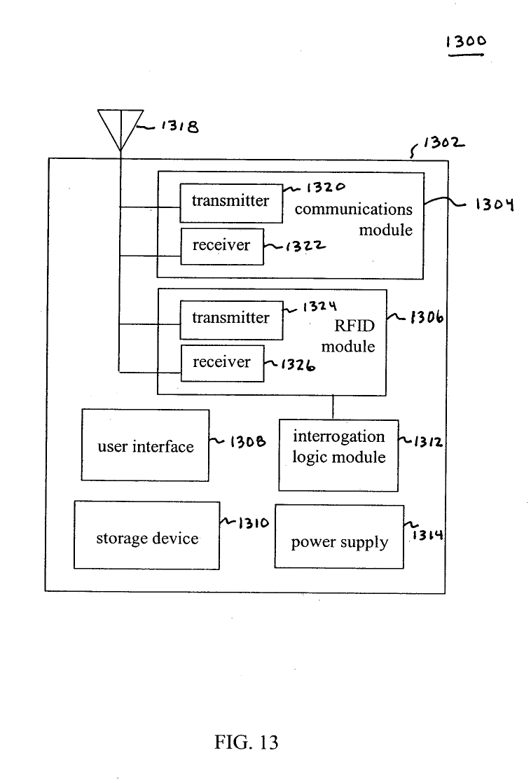

RFID communications device 810 may be one of a variety of device types, including a RFID reader (fixed or mobile), a barcode scanner, a handheld computer, other device mentioned herein, or other known device type. FIG. 13 shows a mobile device 1300, including various example components and/or modules, as an example embodiment of device 810. In FIG. 13, mobile device 1300 includes a communications module 1304, an RFID module 1306, a storage device 1310, a user interface 1308, a interrogation logic module 1312, an antenna 1318, and a power supply 1314. Communications module 1304 includes a transmitter 1320 and a receiver 1322, and RFID module 1306 includes a transmitter 1324 and a receiver 1326, contained by a housing 1302. In an alternative embodiment, communications module 1304 and RFID module 1306 may share a common receiver and transmitter (or transceiver).

RFID module 1306 is configured to perform communications with RFID tags via antenna 1318, such as described above for reader 102 in FIG. 2. Communications module 1304 is configured to enable mobile device 1300 to communicate with a remote entity via antenna 1318. For example, communications module 1304 may be configured similarly to network interface 216 described above with respect to FIG. 2, to communicate data and/or instructions with a remote computer system.

A user interacts with mobile device 1300 through user interface 1308. For example, user interface 1308 can include any combination of one or more finger-operated buttons (such as a “trigger”), a keyboard, a graphical user interface (GUI), indicator lights, and/or other user input and display devices, for a user to interact with mobile device 1300, to cause mobile device 1300 to operate as described herein. User interface 1308 may further include a web browser interface for interacting with web pages and/or an E-mail tool for reading and writing E-mail messages.

Storage device 1314 is used to store information/data for mobile device 1300. Storage device 1310 can be any type of storage medium, including memory circuits (e.g., a RAM, ROM, EEPROM, or FLASH memory), a hard disk/drive, a floppy disk/drive, an optical disk/drive (e.g., CDROM, DVD, etc), etc., and any combination thereof. Storage device 1310 can be built-in storage of mobile device 1300, and/or can be additional storage installed in mobile device 1300.

Power supply 1314 can be any suitable power source for mobile device 1300, including one or more batteries or a power source interface (e.g., for DC or AC power).

Interrogation logic module 1312 is configured to perform multi-round interrogations of tag populations, as described elsewhere herein. For example, interrogation logic module 1312 may be configured to perform one or more of steps 502-518 shown in FIG. 5, and steps 1202-1206 shown in FIG. 12. A user may interact with user interface 1308 to cause interrogation logic module 1312 to perform a multi-round interrogation. For example, a user may enter an estimated number of tags (step 502), a number of rounds (step 504), a Q value (step 506), a transmit power level (step 508), etc., and/or one or more of these values may be determined by interrogation logic module 1312. A user may enter a desired number of query rounds in which to perform an interrogation of a tag population, or interrogation logic module 1312 may determine the number of query rounds that a single query round interrogation may be divided into, according to processes that will be apparent to persons skilled in the relevant art(s) from the teachings herein. Interrogation logic module 1312 may calculate a reduced Q value (step 510), may determine reduced transmit power levels (steps 512, 516, 1202), and may cause RFID module 1306 to perform interrogations of tag populations using the reduced Q value and reduced transmit power levels (steps 514, 518, 1204). Interrogation logic module 1312 may include hardware, software, firmware, or any combination thereof to perform its functions. Thus, interrogation logic module 1312 enables an operator of mobile device 1300 to conduct a multi-query round interrogation of a tag population, according to the processes described above.

Note that, depending on the particular application for the mobile device, mobile device 1300 may include additional or alternative components. For example, mobile device 1300 may include machine readable symbol scanner (e.g., barcode scanner) functionality for scanning machine readable symbols (e.g., barcodes).

### Example Computer System Embodiments

In this document, the terms “computer program medium” and “computer usable medium” are used to generally refer to media such as a removable storage unit, a hard disk installed in hard disk drive, and signals (i.e., electronic, electromagnetic, optical, or other types of signals capable of being received by a communications interface). These computer program products are means for providing software to a computer system. The invention, in an embodiment, is directed to such computer program products.

In an embodiment where aspects of the present invention are implemented using software, the software may be stored in a computer program product and loaded into a computer system using a removable storage drive, hard drive, or communications interface. The control logic (software), when executed by a processor, causes the processor to perform the functions of the invention as described herein.

According to an example embodiment, a RFID device may execute computer-readable instructions to interrogate tag populations, to process tag responses, to determine Q values, to vary transmit power levels, etc.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method for interrogating a radio frequency identification (RFID) tag population, comprising:
estimating a number of tags in a tag population;
determining a number of time slots to interrogate the estimated number of tags in a single query round;
determining a Q value based on the determined number of time slots;
determining a first transmit power level to interrogate the tag population in the single query round;
reducing the determined Q value to generate a reduced Q value;
determining a first reduced transmit power level less than the determined first transmit power level;
performing a first query round to interrogate a first group of tags of the tag population based on the reduced Q value and the first reduced transmit power level;
determining a second reduced transmit power level that is less than the determined first transmit power level and greater than the first reduced transmit power level; and
performing a second query round to interrogate a second group of tags of the tag population based on the reduced Q value and the second reduced transmit power level.

2. The method of claim 1, wherein a combination of the first group of tags and the second group of tags is substantially equal to the tag population.

3. The method of claim 1, further comprising:
determining a third reduced transmit power level that is less than the determined first transmit power level and greater than the second reduced transmit power level; and
performing a third query round to interrogate a third group of tags of the tag population based on the reduced Q value and the third reduced transmit power level.

4. The method of claim 1, wherein a combination of the first group of tags, the second group of tags, and the third group of tags is substantially equal to the tag population.

5. The method of claim 1, further comprising:
determining a subsequent reduced transmit power level that is less than the determined first transmit power level and greater than the second reduced transmit power level;
performing a subsequent query round to interrogate a subsequent group of tags of the tag population based on the reduced Q value and the subsequent reduced transmit power level;
repeating at least once said determining the subsequent reduced transmit power level and said performing the subsequent query round to interrogate a subsequent group of tags of the tag.

6. The method of claim 1, wherein said reducing step comprises:
subtracting one from the determined Q value to generate the reduced Q value.

7. The method of claim 1, wherein said determining the first reduced transmit power level comprises:
calculating the first reduced transmit power level to be substantially equal to the determined first transmit power level×0.50.

8. The method of claim 7, wherein said determining the second reduced transmit power level comprises:
calculating the second reduced transmit power level to be substantially equal to the determined first transmit power level×0.68.

9. The method of claim 8, wherein said estimating step comprises:
basing the estimated number of tags in the tag population on tags arranged in a substantially two-dimensional area.

10. The method of claim 1, wherein said determining the first reduced transmit power level comprises:
calculating the first reduced transmit power level to be substantially equal to the determined first transmit power level×0.63.

11. The method of claim 10, wherein said determining the second reduced transmit power level comprises:
calculating the second reduced transmit power level to be substantially equal to the determined first transmit power level×0.78.

12. The method of claim 11, wherein said estimating step comprises:
basing the estimated number of tags in the tag population on tags arranged in a substantially three-dimensional zone.

13. The method of claim 1, wherein said determining the Q value comprises:
determining the Q value based on the relationship of:
number of time slots=2^{Q}, where Q is an integer.

14. The method of claim 1, wherein said determining a number of time slots comprises:
setting the number of time slots to be ≧ the estimated number of tags.

15. A radio frequency identification (RFID) communications device, comprising:
an antenna;
a transmitter coupled to the antenna, wherein the transmitter is configured to generate at least one interrogation signal that is transmitted by the antenna;
a logic module configured to receive a Q value and a first transmit power level configured to interrogate a tag population in a single query round, wherein the logic module is configured to generate a reduced Q value from the received Q value, to determine a first reduced transmit power level that is less than the determined first transmit power level, and to determine a second reduced transmit power level that is less than the determined first transmit power level and is greater than the first reduced transmit power level.

16. The RFID communications device of claim 15, wherein the transmitter is configured to perform a first query round to interrogate a first group of tags of the tag population based on the reduced Q value and the first reduced transmit power level, and to perform a second query round to interrogate a second group of tags of the tag population based on the reduced Q value and the second reduced transmit power level.

17. The RFID communications device of claim 16, wherein a combination of the first group of tags and the second group of tags is substantially equal to the tag population.

18. The RFID communications device of claim 16, wherein the logic module is configured to determine a third reduced transmit power level that is less than the determined first transmit power level and greater than the second reduced transmit power level; and
wherein the transmitter is configured to perform a third query round to interrogate a third group of tags of the tag population based on the reduced Q value and the third reduced transmit power level.

19. The RFID communications device of claim 18, wherein a combination of the first group of tags, the second group of tags, and the third group of tags is substantially equal to the tag population.

20. The RFID communications device of claim 15, wherein the logic module is configured to subtract one from the determined Q value to generate the reduced Q value.

21. The RFID communications device of claim 15, wherein the logic module is configured to calculate the first reduced transmit power level to be substantially equal to the determined first transmit power level×0.50, and is configured to calculate the second reduced transmit power level to be substantially equal to the determined first transmit power level×0.68.

22. The RFID communications device of claim 15, wherein the logic module is configured to calculate the first reduced transmit power level to be substantially equal to the determined first transmit power level×0.63, and is configured to calculate the second reduced transmit power level to be substantially equal to the determined first transmit power level×0.78.

23. The RFID communications device of claim 15, wherein the RFID communications device is a mobile device.

24. The RFID communications device of claim 23, further comprising:
a user interface configured to enable an operator to interact with the mobile device.

25. The RFID communications device of claim 15, wherein the RFID communications device is a RFID reader.

26. A radio frequency identification (RFID) communications device, comprising:
an antenna;
a transmitter coupled to the antenna, wherein the transmitter is configured to perform a first query round to interrogate a first group of tags of a tag population based on a reduced Q value and a first reduced transmit power level, and to perform a second query round to interrogate a second group of tags of the tag population based on the reduced Q value and a second reduced transmit power level;
wherein the reduced Q value is reduced relative to a Q value configured to interrogate the tag population in a single query round; and
wherein the first reduced transmit power level and second transmit power level are reduced relative to a first transmit power level configured to interrogate the tag population in the single query round.

27. A system for interrogating a radio frequency identification (RFID) tag population, comprising:
means for reducing a Q value configured to interrogate a tag population in a single query round to a reduced Q value;
means for determining a first reduced transmit power level less that is than a first transmit power level configured to interrogate the tag population in the single query round;
means for performing a first query round to interrogate a first group of tags of the tag population based on the reduced Q value and the first reduced transmit power level;
means for determining a second reduced transmit power level that is less than the first transmit power level and greater than the first reduced transmit power level; and
means for performing a second query round to interrogate a second group of tags of the tag population based on the reduced Q value and the second reduced transmit power level.

28. The system of claim 27, further comprising:
means for estimating a number of tags in the tag population;
means for determining a number of time slots to interrogate the estimated number of tags in the single query round;
means for determining the Q value based on the determined number of time slots;
means for determining the first transmit power level to interrogate the tag population in the single query round.
